(19) United States
(12) Patent Application Publication
(10) Pub. No.: US 2012/0000255 A1
(43) Pub. Date: Jan. 5, 2012

(54) LOCKABLE ENCLOSURE WITH LOADING CARTRIDGE

(75) Inventors: Zachery T. Nave, Oak Creek, WI (US); Steven B. Hedlund, Pepper Pike, OH (US); John William Grosz, Waupun, WI (US); Michael Stephen Rafferty, Madison, WI (US); Curtis J. Scadden, Waunakee, WI (US)

(73) Assignee: MASTER LOCK COMPANY LLC, Oak Creek, WI (US)

(21) Appl. No.: 13/077,182

(22) Filed: Mar. 31, 2011

Related U.S. Application Data
(60) Provisional application No. 61/320,434, filed on Apr. 2, 2010.

(51) Int. Cl. E05B 65/52; E05C 3/16

(52) U.S. Cl. 70/63; 292/196

(57) ABSTRACT

A lockable enclosure includes a housing and a loading cartridge assembled with the housing and vertically slidable between a secured position in which a recess of the loading cartridge cannot be accessed through a bottom opening of the housing, and an access position in which at least a portion of the recess extends through at least a portion of the opening, such that a storable item may be withdrawn from the recess. A locking mechanism is assembled with the housing and configured to secure the loading cartridge in the secured position in a locked condition and to release the loading cartridge in an unlocked condition for downward vertical movement from the secured position to the access position. A lock interface assembled with the housing is configured to move the locking mechanism from the locked condition to the unlocked condition in response to proper user manipulation of the lock interface.

### CROSS-REFERENCE TO RELATED APPLICATION

This application claims priority to, and any other benefit of, U.S. Provisional Patent Application Ser. No. 61/320,434, entitled LOCKABLE ENCLOSURE WITH LOADING CARTRIDGE and filed Apr. 2, 2010, the entire disclosure of which is fully incorporated herein by reference.

### BACKGROUND

Lockable enclosures are used in many indoor and outdoor environments to restrict access to various items by providing the enclosure with a lockable door, lid, drawer, or other such barrier. The barrier can be secured in a closed position by a locking mechanism, such as, for example, a combination lock, padlock, push-button operated mechanism, or key operated latch, to limit access to the contents of the enclosure to one or more authorized users. Some applications may require secure storage of one or more smaller items, such as keys, credit cards, or documents, for which restricted access by a limited number of authorized individuals is desirable. One example of such an enclosure is a key safe, which is affixed on or near an entry door (e.g., shackled around the doorknob) of a building for secure retention of an authorized key for the entry door. The key safe may employ, for example, a pushbutton keypad or combination dial locking mechanism, such that authorized users informed of an unlocking combination may open the key safe to access the door key for entry into the building.

### SUMMARY

The present application describes inventive lockable enclosures for restricting access to one or more storable items. In one embodiment, a loading cartridge configured to store one or more items is secured within a housing in a locked condition to block access to the items, and is movable to at least partially extend through an opening in the housing in an unlocked condition, to permit access to the stored items.

Accordingly, in an exemplary embodiment of the present application, a lockable enclosure includes a housing and a loading cartridge assembled with the housing and vertically slidable between a secured position in which a recess of the loading cartridge cannot be accessed through a bottom opening of the housing, and an access position in which at least a portion of the recess extends through at least a portion of the opening, such that a storable item may be withdrawn from the recess. A locking mechanism is assembled with the housing and configured to secure the loading cartridge in the secured position in a locked condition and to release the loading cartridge in an unlocked condition for downward vertical movement from the secured position to the access position. A lock interface assembled with the housing is configured to move the locking mechanism from the locked condition to the unlocked condition in response to proper user manipulation of the lock interface.

In another embodiment, a locking arrangement includes a base member (for example, a housing or frame) and a barrier (for example, a loading cartridge or door) assembled with the base member and movable between a secured position and an access position. A locking mechanism is assembled with one of the base member and the barrier. The locking mechanism is configured to secure the barrier in the secured position when the locking mechanism is in a locked condition, and to release the barrier for movement from the secured position to the access position when the locking mechanism is in an unlocked condition. The locking mechanism includes a pivotable latch member that disengages the barrier when the locking mechanism is moved to the unlocked condition, and an axially slidable driving member connected with the pivotable latch member by at least one pivotable linkage member. A lock interface is assembled with one of the base member and the barrier, and is configured to actuate the driving member to move the locking mechanism from the locked condition to the unlocked condition in response to proper user manipulation of the lock interface.

### BRIEF DESCRIPTION OF THE DRAWINGS

Further features and advantages of the invention will become apparent from the following detailed description made with reference to the accompanying drawings, wherein:

FIG. 1 is a perspective view of a lockable enclosure;

FIG. 2 is a rear perspective view of the lockable enclosure of FIG. 1;

FIG. 3 is a front view of the lockable enclosure of FIG. 1, shown with the loading cartridge in an extended position;

FIG. 4 is an enlarged view of the lock interface of the lockable enclosure of FIG. 1;

FIG. 5 is a partial front view of the lockable enclosure of FIG. 1, with portions removed to show the locking mechanism in a locked condition;

FIG. 6 is a partial front view of the lockable enclosure of FIG. 1, with portions removed to show the locking mechanism in an unlocked condition;

FIG. 7 is a partial perspective view of the lockable enclosure of FIG. 1, with portions removed to show the locking mechanism in an unlocked condition;

FIG. 8 is a partial perspective view of the lockable enclosure of FIG. 1, with portions removed to show the braking mechanism in a retracted condition;

FIG. 9 is a perspective view of the lockable enclosure of FIG. 1, with the housing removed to show additional features of the enclosure; and

FIG. 10 is an exploded perspective view of the lockable enclosure of FIG. 1.

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used have their full ordinary meaning

Also, while the exemplary embodiments described in the specification and illustrated in the drawings relate to an electronic pushbutton keypad safe or lock box sized to store smaller items, such as door keys, it should be understood that many of the inventive features described herein may be applied to other sizes and types of lockable enclosures, including, for example, larger safes and cash boxes, and lockable enclosures utilizing other electromechanical locking mechanisms, including, for example, remote signal operated, biometric sensor operated, and electronic key operated locking mechanisms. Some of the inventive features described herein may be applied to purely mechanical lockable enclosures, including, for example, lockable enclosures including mechanical push-button, combination dial, and key operated locking mechanisms. Further, some of the inventive features described herein may be utilized with other types of locking arrangements including, for example, door locks and window locks.

The present application contemplates a lockable enclosure, such as a key safe, that includes a loading cartridge or retainer that axially slides or drops from a secure cavity within the enclosure for deposit or withdrawal of one or more items to be securely stored within the enclosure. In such an embodiment, a conventional safe door may be eliminated, along with the hinge and seams or gaps around the safe door that may result in weak points or insertion points for lock-picking tools or other means of compromising the secure enclosure.

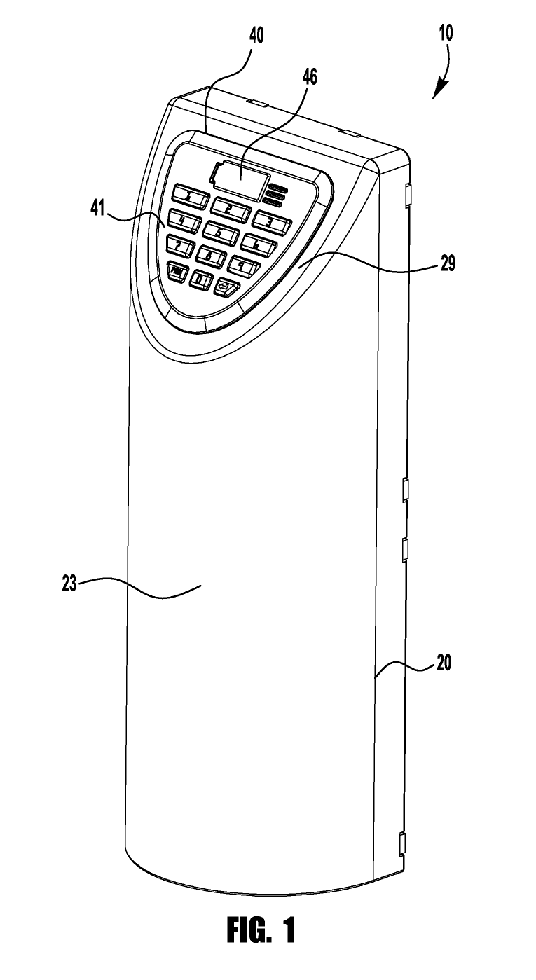

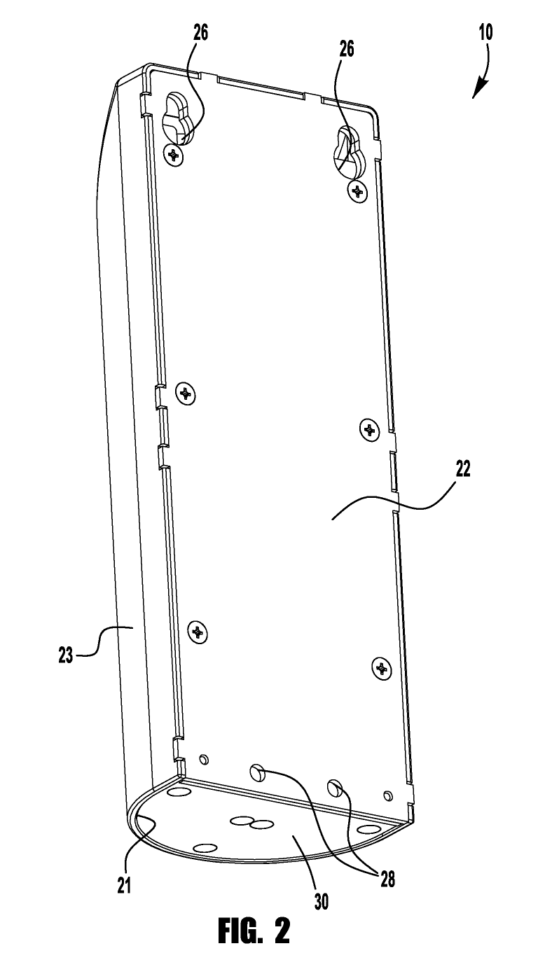

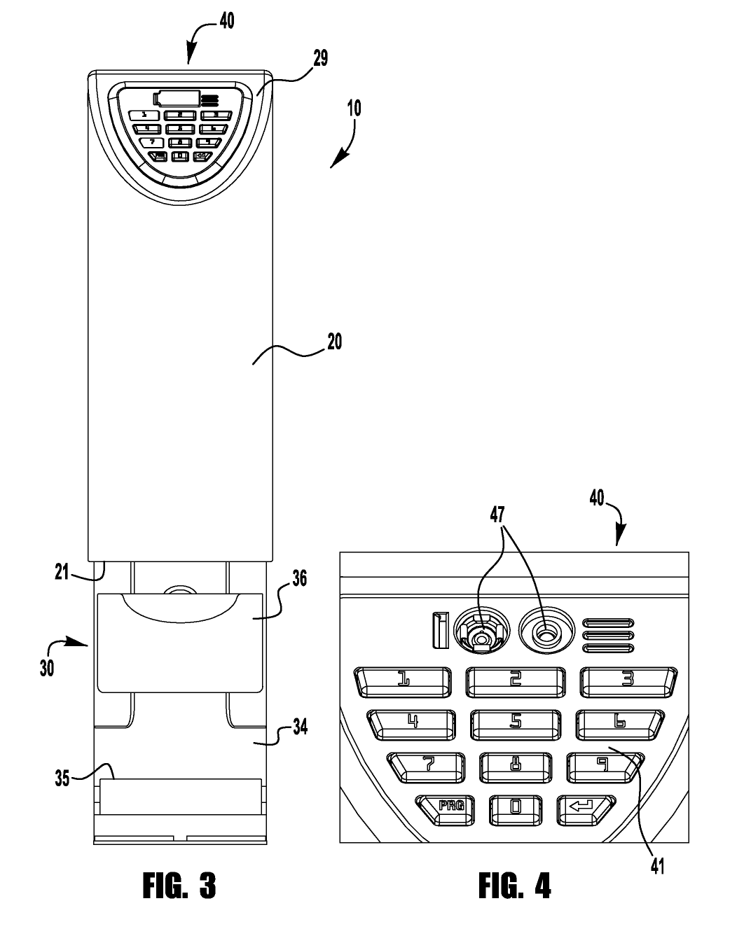

FIGS. 1-10 illustrate an exemplary lockable enclosure 10 having a housing 20 and a loading cartridge 30 assembled with the housing 20 and axially movable or slidable between a secured or retracted position (FIGS. 1 and 2) in which the loading cartridge is disposed entirely within an internal cavity of the housing 20, and an access or extended position (FIG. 3), in which the loading cartridge 30 extends beyond or through an external opening 21 in a bottom portion of the housing 20, such that a storable item (e.g., a mechanical key, credit card, etc.) may be deposited in or withdrawn from a recess defined by the loading cartridge 30. The exemplary loading cartridge 30 includes a back plate 31 (FIG. 10) with slots 33 in which guide members 59 of a fixed plate 24 within the housing 20 are positioned to align the loading cartridge 30 during sliding movement. The loading cartridge 30 may include a panel 34 secured to the back plate 31 to cover the slots 33.

In one embodiment, the lockable enclosure is oriented such that the loading cartridge slides vertically between secured and access positions. In such an arrangement, when a locking mechanism is operated to release the loading cartridge, the loading cartridge may be allowed to automatically drop, through force of gravity, to an extended or access position. While the loading cartridge may be permitted to freely drop when the enclosure is unlocked, a dampening or braking mechanism may be used to slow the drop of the loading tray. In the illustrated embodiment, a coiled flat spring 27 is secured at one end to a reel 25 affixed to the housing 20, and is secured at the other end to the loading cartridge 30. The coiled spring 27 provides relatively constant resistance to the dropping movement of the loading cartridge 30, slowing down the dropping cartridge, for example, to reduce wear of the sliding components and/or to prevent loose contents of the cartridge recesses from falling out of the cartridge.

The housing 20 may be secured to an external structure, such as a wall or a door, by one or more anchoring fasteners (not shown), on which keyhole slotted portions 26 of the housing 20 are hung, and one or more mounting fasteners (not shown) installed in mounting holes 28 in the housing. The mounting holes 28 may be positioned so that the mounting fasteners are only accessible when the loading cartridge 30 is in the extended position, to prevent unauthorized detachment of the lockable enclosure 10.

Disposed on the housing 20 is a lock interface 40. Proper manipulation of the lock interface 40 by an authorized user moves a locking mechanism disposed within the housing 20 (as described in greater detail below) from a locked condition to an unlocked condition to release the loading cartridge 30 for movement to the access position. Many different mechanical lock interfaces may be utilized, including, for example, combination dials, mechanical keyways, and mechanical push-button locking arrangements. In other embodiments, electronic lock interfaces may be employed, which may reduce the risk of physical attack of the locked enclosure. In the illustrated embodiment, the lock interface 40 includes an electronic keypad 41 in electrical communication with a PC board 42 by a PCB cable 43 (FIG. 10) that delivers an electrical signal to the locking mechanism in response to user entry of an authorized combination code on the keypad for movement of the locking mechanism to the unlocked condition. The PC board 42 may be mounted to a support plate 12, which may be positioned to cover and protect the locking mechanism 50. The keypad 41 and PC board 42 may provide for entry of a numbered (or letter-based, symbol based, etc.) combination code, as well as administrator controls, such as addition of new authorized codes, deletion of old or unwanted authorized codes, creation of one-time or duration specific combination codes, or other access control commands. Still other electronic lock interfaces may be utilized, including, for example, biometric sensors (e.g., fingerprint scanners), electronic key readers, and wireless transceivers for receiving a remote unlocking signal.

While the electronic lock interface 40 may be powered by an external power source, in the illustrated embodiment, the lockable enclosure 10 is provided with an internal battery cell 48 electrically connected with the lock interface 40 by an electrical cable 49. To facilitate authorized replacement of a depleted battery, the battery 48 may be assembled with the loading cartridge 30 (for example, spring loaded by retainer 45 against shelf portion 32), such that the battery 48 drops with the cartridge 30 when the enclosure is unlocked, for access to the battery when the loading cartridge 30 is in the extended position. Further, to enable access to the battery 48 when the battery has been fully depleted and unable to power operation of the lock interface and/or locking mechanism, the lock interface 40 may be provided with an external electrical port or contact for connection with an external power source, such as an AC adapter port or battery jump contacts. In the illustrated embodiment, external jump contacts 47 for a 9V battery are provided on the lock interface 40. In the event of a fully depleted battery, a new battery is connected to the jump contacts 47, allowing the authorized combination code to be entered and the locking mechanism to be moved to the unlocked condition. The electrical port or contacts may be protected from moisture and debris by a flap or cover 46.

To further resist forced entry, the housing may be shaped or contoured to impede attacks by hammer blows, drilling, or sawing. For example, cylindrical or rounded external surfaces may replace conventional flat external surfaces that are more prone to drilling or hammer blows, and may also eliminate sharper corners that are more easily sawed with a hacksaw. As shown, the exemplary housing 20 forms a half cylinder, with a flat surface 22 for mounting to a wall, door, or other structure, and a cylindrical outer surface 23 contoured to impede attack. Additionally, a steeply angled or filleted upper surface 29, on which the lock interface 40 is disposed, also impedes rapping by hammer blows or other such attacks.

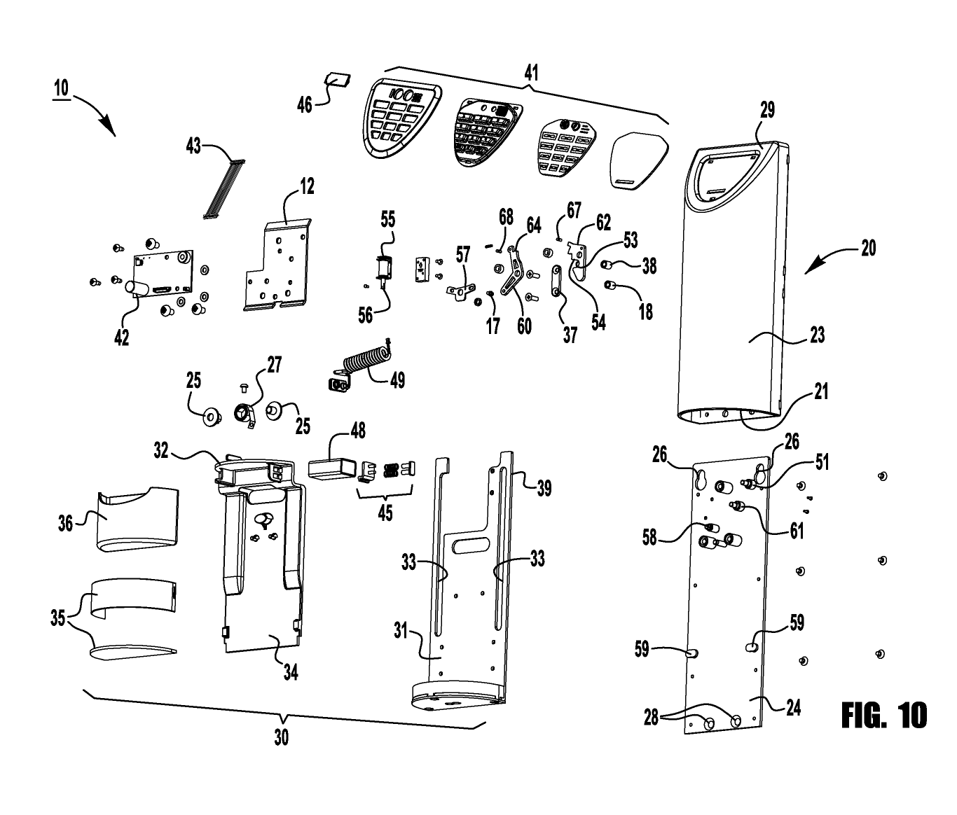

As shown in FIGS. 3 and 9, the recess of the loading cartridge 30 may include a tray 35 and/or a container 36 for retaining one or more items. As shown, the container 36 may be detachable from the panel 34 of the loading cartridge 30 (for example, by a tab and slot engagement) to facilitate loading and unloading of the container 36.

Many different locking mechanisms may be utilized to selectively secure and release a loading cartridge from a secured position, including, for example, various blockers, cams, and latches that engage a portion of the loading cartridge to secure the loading cartridge in the secured position. In one embodiment, a locking mechanism includes a pivotable latch member that is pivoted (i.e., forced or allowed to pivot) from a locked condition, in which the latch member engages a portion of the loading cartridge, to an unlocked condition, in which the latch member disengages from the portion of the loading cartridge for release of the loading cartridge.

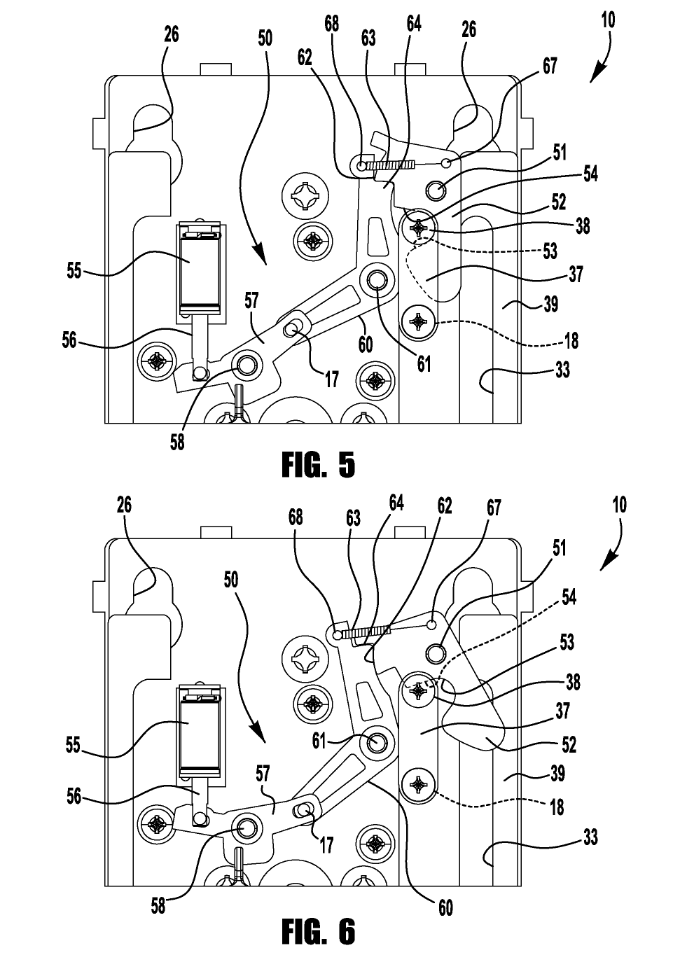

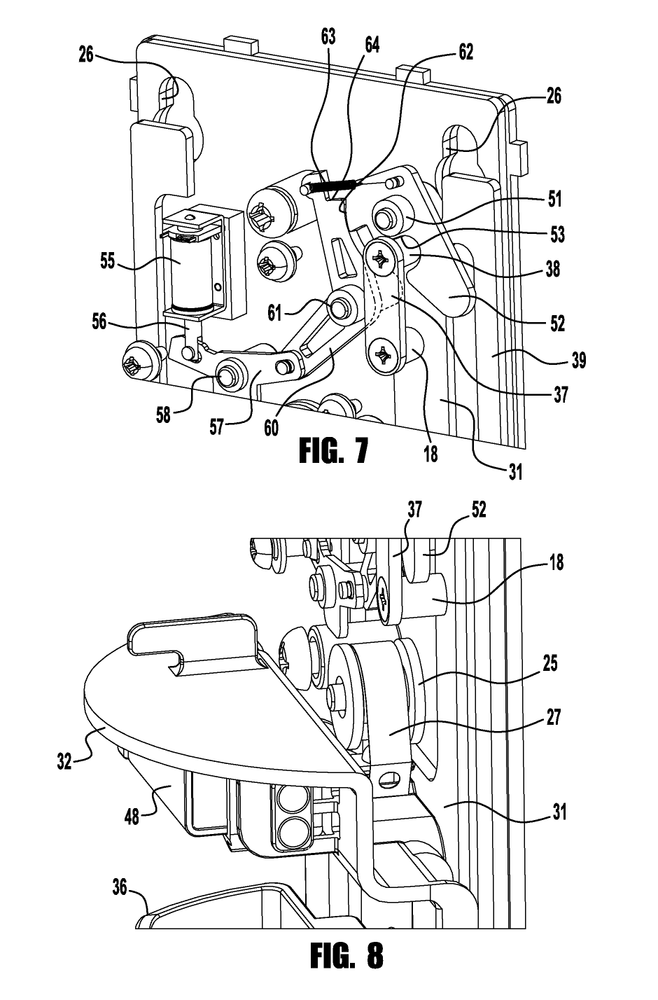

As shown in FIGS. 5-7, the locking mechanism 50 of the illustrated lockable enclosure 10 includes a pivotable latch member 52 pivotable about a central axis of a pivot member 51 (e.g., a pin, fastener, etc.) between a cartridge retaining position (FIG. 5) and a cartridge releasing position (FIGS. 6 and 7). While many types of latching or interlocking engagement may be provided between the latch member 52 and the loading cartridge 30, in the illustrated embodiment, the latch member 52 includes a hook portion 53 that is pivoted to engage and disengage a retaining pin 38 of the loading cartridge 30 between the cartridge back plate 31 and cross bar 37. As shown, the exemplary retaining pin 38 extends substantially parallel to the central axis of the pivot member 51, and is affixed to an arm or extension 39 of the loading cartridge that extends upward from the storage recess of the loading cartridge 30. The latch member 52 may additionally include a camming portion 54 adjacent to the hook portion 53. When the loading cartridge 30 is returned to the retracted or secured position (e.g., by manually lifting or pushing the loading cartridge back into the housing 20), the retaining pin 38 engages the camming portion 54 to pivot the latch member 52 back toward the cartridge retaining position for secure retention of the loading cartridge 30.

Many different actuating or driving members may be employed to selectively move a latch member from a cartridge retaining position to a cartridge releasing position, including, for example, manually or electrically actuated cams, gears, or plungers operable to directly or indirectly move the latch member. In one embodiment, the driving member is an axially movable plunger that directly or indirectly pivots the latch member from the cartridge retaining position to the cartridge releasing position. In the illustrated embodiment, the locking mechanism 50 includes a solenoid 55 with a plunger 56 that functions as an axially movable driving member when an electrical signal is supplied to the energize the solenoid 55, in response to proper manipulation of the lock interface 40 (e.g., entry of an authorized combination code on an electronic keypad). In the illustrated embodiment, the plunger 56 retracts when the solenoid 55 is energized, and remains in the retracted position until the plunger is manually pulled back out to the extended position. Other embodiments may utilize solenoids having plungers that extend when energized, or that automatically return to a de-energized position (e.g., when the electrical signal is withdrawn, or after a set time period), for example, by a spring-loaded or electrically powered arrangement.

While a latch member may be directly actuated by a mechanical or electromechanical driving component, in other embodiments, a driving component may be operatively connected to the latch member by one or more linkage members, which may impede or thwart unlawful efforts to rap, shim, or otherwise force the latch into the cartridge releasing position.

According to an inventive aspect of the present application, a pivotable linkage member connecting a driving component with the latch member may be designed to have a center of mass that substantially coincides with a center of a pivot point of the pivotable linkage member, such that a bumping or jarring force in any direction does not impart a rotational moment to the linkage member. In the illustrated embodiment, the solenoid plunger 56 is connected with a first linkage member 57 that pivots about pivot member 58 in response to axial movement of the plunger 56. The linkage member 57 is designed to have a center of mass that substantially coincides with a center of the pivot member 58, such that a bumping or jarring force applied to the enclosure does not impart a rotational moment to the linkage member 57, and therefore does not contribute to movement of the latch member 52 toward the cartridge releasing position.

According to another inventive aspect of the present application, a linkage member connecting a driving component to a latch member may be provided with a center of mass that moves in an axial direction opposite an axial direction of movement of a center of mass of the driving component when the locking mechanism moves the latch member from the cartridge retaining position to the cartridge releasing position. As a result, a jarring or bumping force applied to move the driving member towards its actuated or cartridge releasing position will simultaneously force the linkage member toward its cartridge retaining position. Likewise, a jarring or bumping force applied to move the linkage member towards its actuated or cartridge releasing position will simultaneously force the driving member toward its cartridge retaining position. In the illustrated embodiment, the linkage member 57 is pivotally connected (by fastener 17) with a second linkage member 60 that pivots about pivot member 61 in response to pivotal movement of the first linkage member 57. The second linkage member 60 is designed to have a center of mass that moves in a vertical direction opposite vertical direction of movement of the solenoid plunger 56 when the locking mechanism 50 moves the latch member 52 from the cartridge retaining position to the cartridge releasing position. As a result, a jarring or bumping force applied to move the solenoid plunger 56 towards its actuated or cartridge releasing position will simultaneously force the second linkage member 60 to pivot toward its cartridge retaining position. Likewise, a jarring or bumping force applied to pivot the second linkage member 60 towards its actuated or cartridge releasing position will simultaneously force the solenoid plunger 56 toward its cartridge retaining position.

According to still another inventive aspect of the present application, a connection between a driving component and the latch member may be dampened by a dampening component (e.g., by a spring or other such biasing member), such that forces applied to rap or jar the latch toward the cartridge releasing position are substantially absorbed by the dampening component, thereby minimizing or eliminating any resultant movement of the latch member. In the illustrated embodiment, the second linkage member 60 is connected to the latch member 52 by a spring member 63 (between pins 67, 68), which functions as a dampening component to absorb or counter any overall opening force that may be impacted upon the second linkage member 60 (for example, by sequenced or rhythmic bumping of the plunger 56 and first linkage member 57).

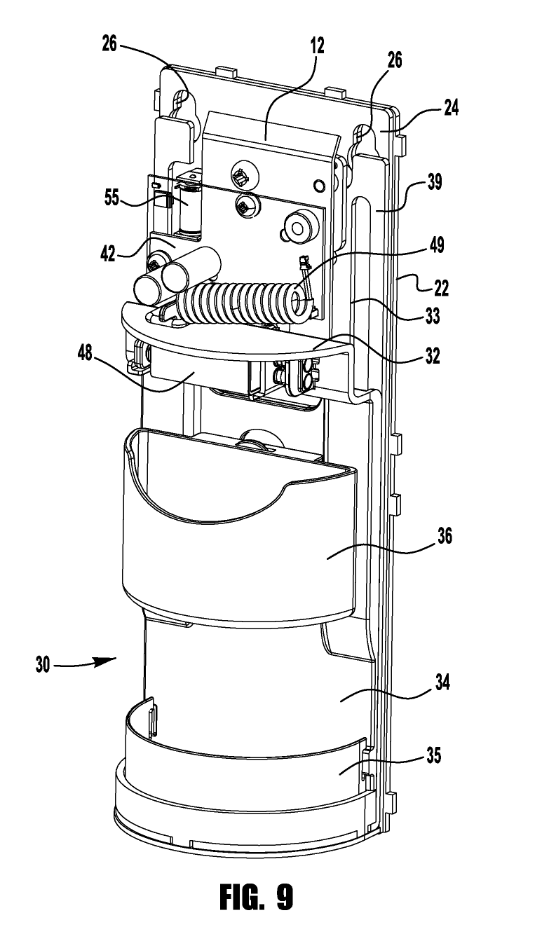

To limit or prevent bumped rotation of the latch member 52, the latch member 52 may be provided with a linkage interlock feature 62 shaped to interlock with a corresponding latch interlock feature 64 of the second linkage member 60. As a result, a bumped rotational force applied to the latch member 52 (in a counter-clockwise direction, as shown), without a corresponding counterclockwise rotation of the second linkage member 60, results in blocked rotation of the latch member 52 by the interlocking features 62, 64. As shown, the shape and orientation of the second linkage member 60 may be selected such that a bumping force oriented to impart a counter-clockwise rotational force on the latch member 52 either passes through the pivot member 61 of the second linkage member 60 or acts to apply a countering clockwise rotational force on the second linkage member 60. Rotation of the latch member 52 may additionally be limited in the clockwise direction (e.g., by a blocking pin 18 extending between the cartridge arm 39 and the cross bar 37), as shown in FIGS. 7 and 8), for example, to limit rotational momentum of the latch member 52.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A lockable enclosure comprising:
a housing defining an internal cavity extending vertically from a bottom portion, said bottom portion having an opening;
a loading cartridge at least partially disposed within the internal cavity and defining a recess for receiving a storable item, the loading cartridge being assembled with the housing and vertically slidable between a secured position in which the recess cannot be accessed through the opening, and an access position in which at least a portion of the recess extends through at least a portion of the opening, such that the storable item may be withdrawn from the recess;
a locking mechanism assembled with the housing, the locking mechanism being configured to secure the loading cartridge in the secured position when the locking mechanism is in a locked condition, the locking mechanism further being configured to release the loading cartridge for downward vertical movement from the secured position to the access position when the locking mechanism is in an unlocked condition; and
a lock interface assembled with the housing, the lock interface being configured to move the locking mechanism from the locked condition to the unlocked condition in response to proper user manipulation of the lock interface.

2. The lockable enclosure of claim 1, wherein the locking mechanism comprises a pivotable latch member that disengages the loading cartridge when the locking mechanism is moved to the unlocked condition.

3. The lockable enclosure of claim 2, wherein the pivotable latch member engages and disengages from a pin member of the loading cartridge, the pin member extending parallel to a pivot axis of the pivotable latch member.

4. The lockable enclosure of claim 2, wherein the locking mechanism further comprises an axially movable driving member connected with the pivotable latch member.

5. The lockable enclosure of claim 4, wherein the axially movable driving member is connected with the pivotable latch member by at least one pivotable linkage member.

6. The lockable enclosure of claim 5, wherein when the locking mechanism is moved to the unlocked condition, a center of mass of one of the at least one linkage members moves in a vertical direction opposite a vertical direction of movement of the axially movable driving member.

7. The lockable enclosure of claim 5, wherein one of the at least one linkage members is connected to the pivotable latch member by a spring member.

8. The lockable enclosure of any claim 5, wherein the latch member and one of the at least one linkage members each include interlocking features that interlock to prevent pivoting of the latch member to the release position prior to pivoting of the one of the at least one linkage members.

9. The lockable enclosure of claim 4, wherein the axially movable driving member is connected with the pivotable latch member by first and second pivotable linkage members.

10. The lockable enclosure of claim 4, wherein the axially movable driving member includes a solenoid and the lock interface delivers an electrical signal to the solenoid in response to proper user manipulation of the lock interface for movement of the locking mechanism to the unlocked condition.

11. The lockable enclosure of claim 1, further comprising a braking mechanism connected between the housing and the loading cartridge to dampen movement of the loading cartridge from the secured position to the access position.

12. The lockable enclosure of claim 11, wherein the braking mechanism comprises a coiled flat spring.

13. The lockable enclosure of claim 1, wherein the locking mechanism is powered by a battery cell, the battery cell being assembled with the loading cartridge, such that the battery cell is accessible when the loading cartridge is in the access position.

14. The lockable enclosure of claim 1, wherein the lock interface comprises an electronic keypad.

15. The lockable enclosure of claim 1, wherein the locking mechanism is moved from the unlocked condition to the locked condition in response to user movement of the loading cartridge from the access position to the secured position.

16. A locking arrangement comprising:
a base member;
a barrier assembled with the base member and movable between a secured position and an access position;
a locking mechanism assembled with one of the base member and the barrier, the locking mechanism being configured to secure the barrier in the secured position when the locking mechanism is in a locked condition, the locking mechanism further being configured to release the barrier for movement from the secured position to the access position when the locking mechanism is in an unlocked condition, the locking mechanism comprising a pivotable latch member that disengages the barrier when the locking mechanism is moved to the unlocked condition, and an axially slidable driving member connected with the pivotable latch member by at least one pivotable linkage member; and
a lock interface assembled with the one of the base member and the barrier, the lock interface being configured to actuate the driving member to move the locking mechanism from the locked condition to the unlocked condition in response to proper user manipulation of the lock interface.

17. The locking arrangement of claim 16, wherein when the locking mechanism is moved to the unlocked condition, a center of mass of one of the at least one pivotable linkage members moves in a vertical direction opposite a vertical direction of movement of the axially movable driving member.

18. The locking arrangement of claim 16, wherein the latch member and one of the at least one linkage members each include interlocking features that interlock to prevent pivoting of the latch member to the release position prior to pivoting of the one of the at least one linkage members.

19. The locking arrangement of claim 16, wherein the axially movable driving member includes a solenoid and the lock interface delivers an electrical signal to the solenoid in response to proper user manipulation of the lock interface for movement of the locking mechanism to the unlocked condition.

20. A lockable enclosure comprising:
a housing defining an internal cavity extending vertically from a bottom portion, said bottom portion having an opening;
a loading cartridge at least partially disposed within the internal cavity and defining a recess for receiving a storable item, the loading cartridge being assembled with the housing and vertically slidable between a secured position in which the recess cannot be accessed through the opening, and an access position in which at least a portion of the recess extends through at least a portion of the opening, such that the storable item may be withdrawn from the recess;
a locking mechanism assembled with the housing, the locking mechanism being configured to secure the loading cartridge in the secured position when the locking mechanism is in a locked condition, the locking mechanism further being configured to release the loading cartridge for downward vertical movement from the secured position to the access position when the locking mechanism is in an unlocked condition, the locking mechanism comprising a pivotable latch member that disengages the barrier when the locking mechanism is moved to the unlocked condition, and an axially slidable driving member connected with the pivotable latch member by at least one pivotable linkage member, wherein the locking mechanism is moved from the unlocked condition to the locked condition in response to user movement of the loading cartridge from the access position to the secured position;
a lock interface assembled with the housing, the lock interface being configured to move the locking mechanism from the locked condition to the unlocked condition in response to proper user manipulation of the lock interface; and
a braking mechanism connected between the housing and the loading cartridge to dampen movement of the loading cartridge from the secured position to the access position, the braking mechanism comprising a coiled flat spring.
